(19) United States
(12) Patent Application Publication
(10) Pub. No.: US 2024/0235914 A1
(43) Pub. Date: Jul. 11, 2024

(54) FREQUENCY DIVERSITY IN SINGLE-CARRIER COMMUNICATIONS

(71) Applicant: HUAWEI TECHNOLOGIES CO., LTD., SHENZHEN (CN)

(72) Inventors: MING JIA, KANATA (CA); JIANGLEI MA, KANATA (CA)

(21) Appl. No.: 18/444,604

(22) Filed: Feb. 16, 2024

Related U.S. Application Data
(63) Continuation of application No. PCT/CN2021/114188, filed on Aug. 24, 2021.

(51) Int. Cl. H04L 27/26

(52) U.S. Cl. CPC H04L 27/2636; H04L 27/2602

(57) ABSTRACT

The present disclosure relates to providing frequency diversity in single-carrier communications. A first time domain signal that is based on a first frequency domain signal is transmitted, and a second time domain signal that is based on a second frequency domain signal is transmitted. The first frequency domain signal results from conversion of a sequence of modulation symbols to frequency domain and includes multiple frequency domain components. The second frequency domain signal is consistent with a cyclic shift of the frequency domain components of the first frequency domain signal. The first time domain signal and the second time domain signal are transmitted as a transmission and a retransmission related to an input from which the sequence of modulation symbols is generated.

### CROSS REFERENCE TO RELATED APPLICATION

This application is a continuation of International Application No. PCT/CN2021/114188, entitled “FREQUENCY DIVERSITY IN SINGLE-CARRIER COMMUNICATIONS” and filed on Aug. 24, 2021, the disclosure of which is hereby incorporated by reference in its entirety.

### TECHNICAL FIELD

The application relates to wireless communications generally, and more particularly to providing frequency diversity in single-carrier communications.

### BACKGROUND

Orthogonal frequency division multiplexing (OFDM) is a popular choice for modern wireless communication systems, due to its performance, scheduling flexibility, and ease in employing multiple-input multiple-output (MIMO) techniques. However, OFDM has high peak to average power ratio (PAPR). For this reason, single-carrier (SC)-based waveforms, such as discrete Fourier transform—spread—orthogonal frequency division multiplexing (DFT-S-OFDM) has also been adopted in 3^{rd} generation partnership project (3GPP) standards. Single-carrier offset quadrature amplitude modulation (SC-OQAM) is another single-carrier candidate to reduce PAPR. For example, π/2-BPSK (binary phase shift keying), which has also been adopted by 3GPP, provides a waveform that is close to an SC-OQAM waveform.

OFDM-based waveforms and SC-based waveform exhibit different performance in frequency selective channels. This is because in OFDM, de-mapped data on each subcarrier can be weighted properly by its signal-to-noise ratio (SNR), and this information can be used by a soft-decision forward error correction (FEC) decoder. When there are deep fades, the effect of these fades can be like puncturing some bits, resulting in a higher code rate. In an SC-based waveform, however, the effect of deep fades is spread to all data. In other words, in an SC-based waveform, at the input of a FEC decoder, each bit from the same DFT-S-OFDM symbol for example, will have the same SNR. The effective code rate will remain the same, but the input to the FEC decoder will be distorted by deep fades. When deep fades are severe, FEC becomes ineffective, because the input becomes too distorted to correct. This is why, when PAPR is not a primary consideration, OFDM is generally preferred over SC-based approaches.

The performance disadvantage associated with SC-based approaches such as DFT-S-OFDM relative to OFDM occurs primarily when a channel is frequency selective. When a channel is flat, OFDM and DFT-S-OFDM have the same performance. This is because in the case of a flat channel, so-called “frequency diversity” in OFDM, which can be achieved via proper SNR weighting of QAM symbol log likelihood ratios (LLRs) and a soft-decision FEC decoder in OFDM for example, is no longer an advantage because DFT-S-OFDM also does not need this kind of information. In particular, in DFT-S-OFDM all QAMs are assumed to have the same SNR. Therefore, DFT-S-OFDM does not need information to weight each QAM differently, and in fact DFT-S-OFDM cannot weight each QAM differently.

Frequency diversity, in the context of OFDM, means that up-fading subcarriers can have greater positive impact, or “pull the weight” in detecting a signal. In SC-based approaches such as DFT-S-OFDM, it is not a question of signal elements or components that pull the weight in signal detection, but rather signal elements or components corrupt the signal. Achieving an equivalent flatter channel may help avoid severe distortion in DFT-S-OFDM. For example, a form of frequency diversity in DFT-S-OFDM is conventionally achieved via narrow-band (that is, flat sub-band) hopping, and time domain proper SNR weighting and soft-decision FEC decoding. However, frequency hopping usually results in degraded performance in channel estimation. In addition, in some systems, such as a wide-band system, frequency hopping is not feasible.

### SUMMARY

Although SC-based approaches may be preferred for reducing PAPR relative to other approaches such as OFDM, SC-based approaches can be inferior to OFDM in frequency-selective channels for example. For a FEC coded signal, OFDM block error rate (BLER) curves tend to have steeper slope than BLER curves for single-carrier counterparts. With insufficient frequency diversity, the BLER curve of an SC waveform becomes flatter.

According to embodiments disclosed herein, retransmission provides a form of frequency diversity that can potentially be more effective than incremental redundancy (IR). An approach that is referred to herein as “mode diversity” provides a flatter effective channel and thereby provides frequency diversity via repetitive retransmission, at almost no additional cost in terms of hardware and implementation complexity. Although “mode diversity” is used primarily in the present disclosure, approaches that are consistent with disclosed embodiments may be referred to using other terms, herein and/or elsewhere.

A method according to one aspect of the present disclosure involves transmitting a first time domain signal that is based on a first frequency domain signal, and transmitting a second time domain signal that is based on a second frequency domain signal. The first frequency domain signal results from conversion of a sequence of modulation symbols to frequency domain and comprises a plurality of frequency domain components. The second frequency domain signal is consistent with a cyclic shift of the frequency domain components of the first frequency domain signal. Transmitting the first time domain signal and transmitting the second time domain signal comprise a transmission and a retransmission related to an input from which the sequence of modulation symbols is generated.

According to another aspect of the present disclosure, an apparatus includes a processor and a non-transitory computer readable storage medium, coupled to the processor, storing programming for execution by the processor. The programming includes instructions to transmit a first time domain signal that is based on a first frequency domain signal, and transmit a second time domain signal that is based on a second frequency domain signal. The first frequency domain signal results from conversion of a sequence of modulation symbols to frequency domain and comprises a plurality of frequency domain components, and the second frequency domain signal is consistent with a cyclic shift of the frequency domain components of the first frequency domain signal. Transmitting the first time domain signal and transmitting the second time domain signal comprise a transmission and a retransmission related to an input from which the sequence of modulation symbols is generated.

A computer program product comprises a non-transitory computer readable medium storing programming, and the programming includes instructions to transmit a first time domain signal that is based on a first frequency domain signal and transmit a second time domain signal that is based on a second frequency domain signal. As in other embodiments, the first frequency domain signal results from conversion of a sequence of modulation symbols to frequency domain and comprises a plurality of frequency domain components, the second frequency domain signal is consistent with a cyclic shift of the frequency domain components of the first frequency domain signal, and transmitting the first time domain signal and transmitting the second time domain signal comprise a transmission and a retransmission related to an input from which the sequence of modulation symbols is generated.

Yet another aspect of the present disclosure relates to a method that involves receiving a first time domain signal that is based on a first frequency domain signal and receiving a second time domain signal that is based on a second frequency domain signal. The first frequency domain signal results from conversion of a sequence of modulation symbols to frequency domain and comprises a plurality of frequency domain components, the second frequency domain signal is consistent with a cyclic shift of the frequency domain components of the first frequency domain signal, and the first time domain signal and the second time domain signal are transmitted as a transmission and a retransmission related to an input from which the sequence of modulation symbols was generated.

An apparatus according to a further aspect of the present disclosure comprises a processor and a non-transitory computer readable storage medium, coupled to the processor, storing programming for execution by the processor. The programming includes instructions to receive a first time domain signal that is based on a first frequency domain signal, and receive a second time domain signal that is based on a second frequency domain signal. The first frequency domain signal results from conversion of a sequence of modulation symbols to frequency domain and comprises a plurality of frequency domain components, and the second frequency domain signal is consistent with a cyclic shift of the frequency domain components of the first frequency domain signal. The first time domain signal and the second time domain signal are transmitted as a transmission and a retransmission related to an input from which the sequence of modulation symbols was generated.

A computer program product comprises a non-transitory computer readable medium storing programming, and the programming includes instructions to receive a first time domain signal that is based on a first frequency domain signal, and receive a second time domain signal that is based on a second frequency domain signal. The first frequency domain signal results from conversion of a sequence of modulation symbols to frequency domain and comprises a plurality of frequency domain components, the second frequency domain signal is consistent with a cyclic shift of the frequency domain components of the first frequency domain signal, and the first time domain signal and the second time domain signal are transmitted as a transmission and a retransmission related to an input from which the sequence of modulation symbols is generated.

Other aspects and features of embodiments of the present disclosure will become apparent to those ordinarily skilled in the art upon review of the following description.

### BRIEF DESCRIPTION OF THE DRAWINGS

For a more complete understanding of the present embodiments, and potential advantages thereof, reference is now made, by way of example, to the following descriptions taken in conjunction with the accompanying drawings.

FIG. 1 is a block diagram that provides a simplified schematic illustration of a communication system.

FIG. 2 is a block diagram illustrating another example communication system.

FIG. 3 is a block diagram illustrating example electronic devices and network devices.

FIG. 4 is a block diagram illustrating units or modules in a device.

FIG. 5 includes plots illustrating frequency domain signals corresponding to a transmission and a retransmission according to an embodiment.

FIG. 6 includes plots illustrating frequency domain signals and transmitter processing corresponding to a transmission according to another embodiment.

FIG. 7 includes plots illustrating frequency domain signals and receiver processing corresponding to the frequency domain signals and transmitter processing in FIG. 6.

FIG. 8 includes plots illustrating frequency domain signals corresponding to a transmission and a retransmission according to the embodiment in FIGS. 6 and 7.

FIG. 9 is a flow diagram illustrating example transmit-side and receive-side methods according to embodiments.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

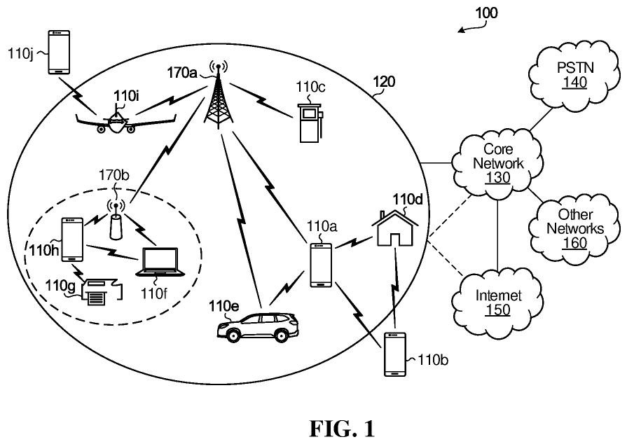

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

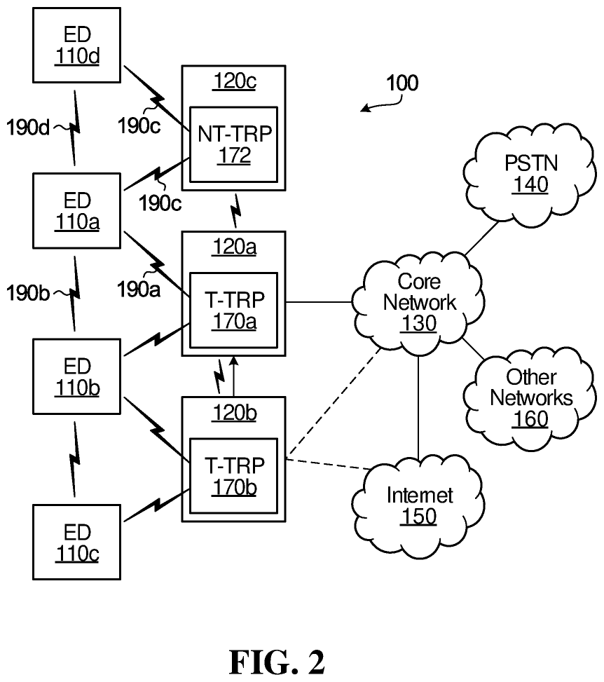

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the Eds 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of Eds and one or multiple NT-TRPs for multicast transmission.

The RANs 120a and 120b are in communication with the core network 130 to provide the Eds 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or Eds 110a 110b, and 110c or both, and (ii) other networks (such as the PSTN 140, the internet 150, and the other networks 160). In addition, some or all of the Eds 110a 110b, and 110c may include functionality for communicating with different wireless networks over different wireless links using different wireless technologies and/or protocols. Instead of wireless communication (or in addition thereto), the Eds 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). Eds 110a 110b, and 110c may be multimode devices capable of operation according to multiple radio access technologies, and incorporate multiple transceivers necessary to support such technologies.

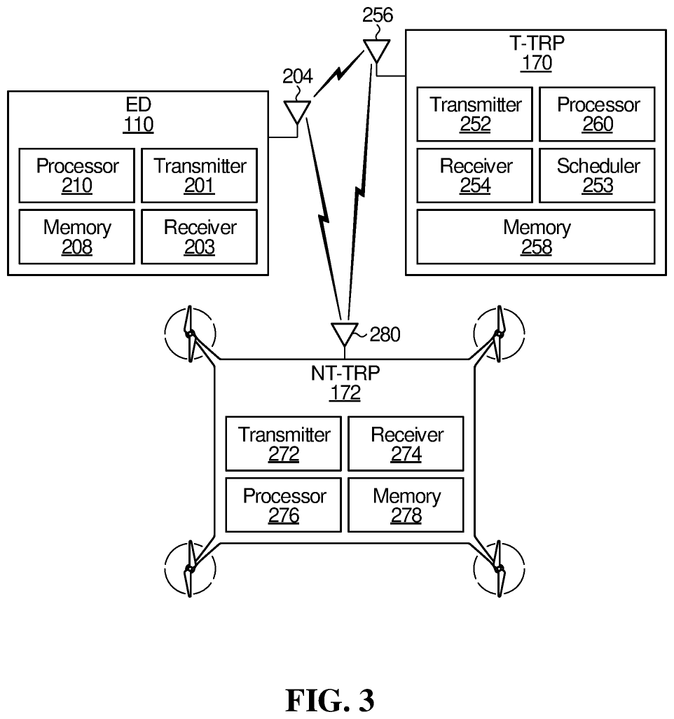

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation Eds 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

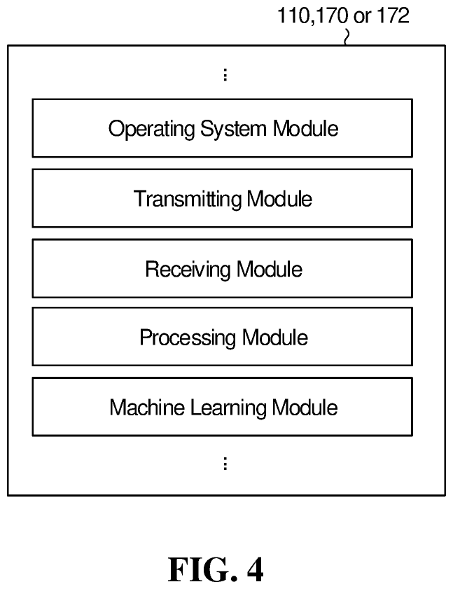

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the Eds 110, T-TRP 170, and NT-TRP 172 are known to those of skill in the art. As such, these details are omitted here.

Some embodiments of the present disclosure are intended to improve performance of retransmission of DFT-S-OFDM and SC-OQAM via mode diversity, without requiring significantly increased complexity or signaling. Fundamentally, mode diversity may provide frequency diversity for a single-carrier waveform, so as to create an equivalent flat frequency domain channel.

In a DFT-S-OFDM based system for example, as in other types of systems, retransmission may be part of a hybrid automatic repeat request (H-ARQ) process or be performed to provide coverage enhancement. IR may be effective when code rate is high because IR can bring about additional coding gain. When code rate is relatively low, however, mode diversity can be more effective because it can make a frequency selective channel approach an additive white Gaussian noise (AWGN) channel.

In some embodiments, there are two modes of operation related to DFT-S-OFDM and SC-OQAM waveforms, which do not change the properties of the waveforms (e.g. π/4-QPSK (quadrature phase shift keying) and SC-OQAM). One mode is referenced herein as mode-1 for ease of reference, and uses a frequency domain signal, which may be a DFT output in some embodiments, for frequency domain spectrum shaping (FDSS). Another mode is referenced herein as mode-2 for ease of reference, and uses a cyclic shift (half of the DFT size) of the DFT output for FDSS. In these modes, the same frequency domain components of a frequency domain signal are now transmitted at different frequency locations, and accordingly after combining of the received signals at a receiver, through maximum-ratio combining (MRC) for example, frequency diversity is achieved.

Turning to a more detailed example, these two different modes may be exploited to achieve frequency diversity in a single-channel approach, in particular DFT-S-OFDM in the following example.

In DFT-S-OFDM, an M-point DFT is applied to an incoming sequence of QAM symbols d(n), n=0, . . . , M−1, also referred to herein as a sequence of modulation symbols generated from an input signal. The DFT output is a frequency domain signal that includes frequency domain components, and may be denoted x(k), k=0, . . . , M−1. After resource mapping, an inverse fast Fourier transform (IFFT) of length N is applied to the frequency domain signal, thus generating a corresponding time domain signal for transmission. This is a simplified and general example, and other operations may also be performed.

In a conventional retransmission strategy, x(k), k=0, . . . , M−1 is transmitted again. However, in one embodiment of mode diversity, a frequency domain signal is consistent with a cyclic shift of x(k). For example, a cyclic shift may be applied to x(k) to shift x(k) by M/2, and create a new sequence of frequency domain components:

x(k), k=M/2,M/2+1, . . . ,M−1,0,1, . . . ,M/2−1 (1)

in retransmission. This is equivalent to reversing, inverting, or flipping the signs of alternate modulation symbols d(n), n=1, 3, . . . , M−1, where M is usually an even number. Consider π/4-QPSK as an example. In π/4-QPSK, time-domain signals are alternately selected from constellations {1, j, −1, −j} and {1+j, −1+j, −1−j, 1−j}/\sqrt{2}. To maintain this property, the other mode(s) that are used in mode diversity also follow this selection “property”, and signals are alternately selected from constellations {1, j, −1, −j} and {1+j, −1+j, −1−j, 1−j}/\sqrt{2}. Frequency domain cyclic shifting between modes does not change a signal taken from {1, j, −1, −j} to a signal taken from a different constellation in this example. The signs of d(n) in this example may be considered random, and therefore an operation that involves reversing the signs of alternate symbols in a sequence of modulation symbols, which would be every second QAM symbol in this example, does not affect the property of the waveform (e.g. π/4-QPSK).

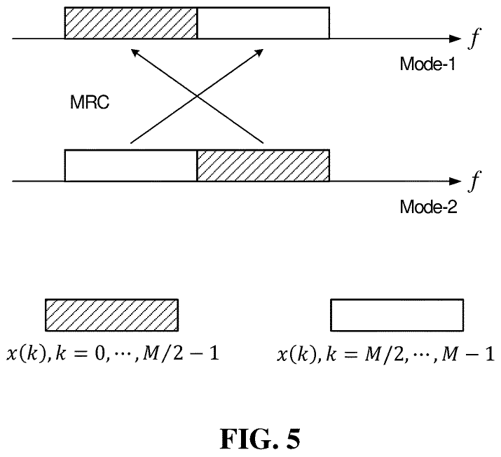

FIG. 5 includes plots illustrating frequency domain signals corresponding to a transmission and a retransmission according to an embodiment. A mode-1 transmission may be an original transmission, for example, corresponding to a frequency domain signal that is centered at M/2 as shown by the upper plot in FIG. 5. A mode-2 retransmission corresponds to a frequency domain signal that is centered at 0 in this example, as shown by the lower plot in FIG. 5. The different patterns for subsets of the frequency domain components illustrates that the “left” and “right” half signals are switched in retransmission. This provides a maximum frequency separation and maximum diversity in a given bandwidth.

Frequency diversity can thereby be achieved in repetition-based retransmission using a DFT-S-OFDM waveform, with little additional complexity associated with a cyclic shift. Signaling impact may involve additional signaling to indicate a current mode, as discussed in further detail below, but need not add significant signaling burden or overhead.

Other embodiments exploit different modes to achieve frequency diversity in SC-OQAM.

In an illustrative example of SC-OQAM, a length-M QAM sequence {d(n), n=0, . . . , M} is separated into real and imaginary symbols: {dᵣ(0), dᵢ(0), dᵣ(1), . . . , dᵢ(M−2), dᵣ(M−1), dᵢ(M−1)}. After a 2M-point DFT, the DFT output may be expressed as x(k), k=0, . . . , 2M −1. FDSS is usually applied on x(k) with a window, such as a root-raised cosine (RRC) window, centered at x(M). The length of the window is typically 2L −1, with 1+M/2<L<M. After resource mapping, a system IFFT of length N is applied to the frequency domain signal, thus generating a corresponding time domain signal for transmission.

Mode diversity may be implemented in retransmission by generating a frequency domain signal that is consistent with a cyclic shift of x(k), such as by cyclic shifting x(k) by M to create a new sequence of frequency domain components:

x(k), k=M,M+1, . . . ,2M−1,0,1, . . . ,M−1 (2)

in retransmission, which is equivalent to reversing the signs of alternate symbols, dᵢ(n), n=0, 1, . . . , M−1. Similar to the above example of π/4-QPSK, in an SC-OQAM embodiment, time domain signals are in the form of real, imaginary, real, imaginary, etc., and to maintain this property a symbol that was real in a sequence of symbols should remain real after a cyclic shift, and a symbol that was imaginary should remain imaginary. The signs of {dᵢ(n)} in this example may be considered random, and therefore reversing the signs of {dᵢ(n)} will not affect the property of the waveform. For mode-2, the FDSS window is centered at x(0) rather than at x(M) as in mode-1.

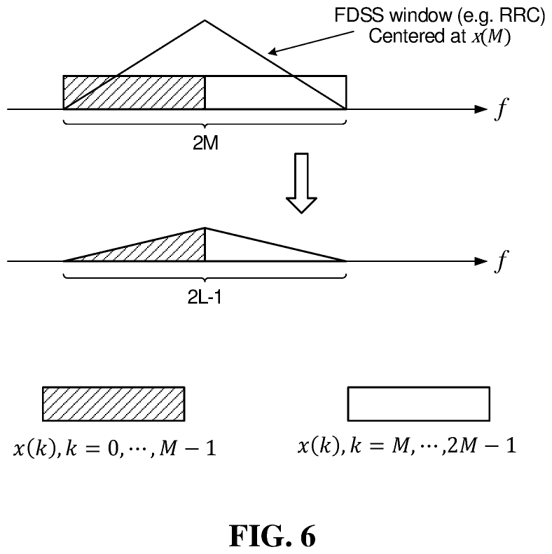

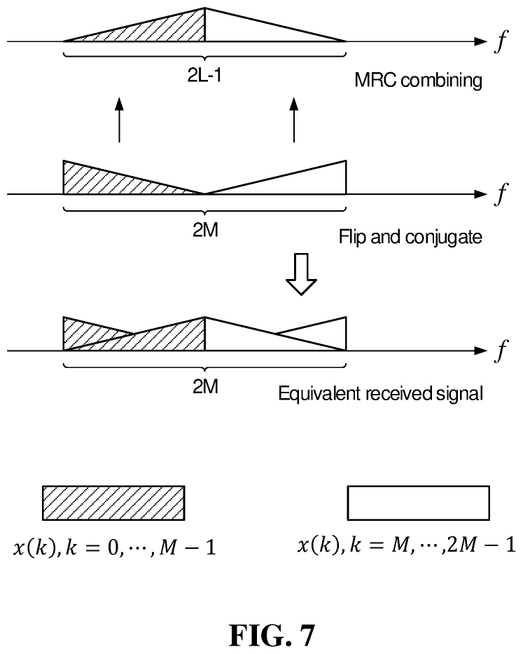

FIG. 6 includes plots illustrating frequency domain signals and transmitter processing corresponding to a transmission according to another embodiment. FIG. 7 includes plots illustrating frequency domain signals and receiver processing corresponding to the frequency domain signals and transmitter processing in FIG. 6. As an example, FIG. 6 illustrates frequency domain mode-1 processing at a transmitter, and FIG. 7 illustrates frequency domain mode-1 processing at a receiver.

With \tilde{x}(k) denoting a received frequency domain signal, y denoting a combined signal in FIG. 7, h(k) denoting the channel at sub-carrier k, and σₙ² denoting the variance of noise:

$$\{ \begin{matrix}y ( 0 ) = \frac{h ( M ) {\tilde{x}}^{*} ( M )}{{\vert h ( M ) \vert}^{2} + {σ}_{n}^{2}} & \\ y ( k ) = \frac{h ( M - k ) {\tilde{x}}^{*} ( M - k ) + {h}^{*} ( k ) \tilde{x} ( k )}{{\vert h ( M - k ) \vert}^{2} + {\vert h ( k ) \vert}^{2} + {σ}_{n}^{2}} , & k = 1 , … , M - 1 \\ y ( M ) = \frac{{h}^{*} ( M ) \tilde{x} ( M )}{{\vert h ( M ) \vert}^{2} + {σ}_{n}^{2}} & \\ y ( k ) = \frac{h ( 3 M - k ) {\tilde{x}}^{*} ( 3 M - k ) + {h}^{*} ( k ) \tilde{x} ( k )}{{\vert h ( 3 M - k ) \vert}^{2} + {\vert h ( k ) \vert}^{2} + {σ}_{n}^{2}} , & k = M + 1 , … , 2 M - 1\end{matrix}$$

The transmitted signal {dᵣ(0), dᵢ(0), dᵣ(1), . . . , dᵢ(M −2), dᵣ(M −1), dᵢ(M−1)} is recoverable by passing {y(k)} through a 2M-point inverse DFT (IDFT).

Mode-2 retransmission is similar to mode-1 in this example, with the difference that the mode-2 frequency domain signal is cyclically shifted M times, as shown in equation (2) above. A cyclic shift may be applied to the frequency domain signal or generated in some other way, through one or more operations applied to an input and/or a sequency of modulation symbols.

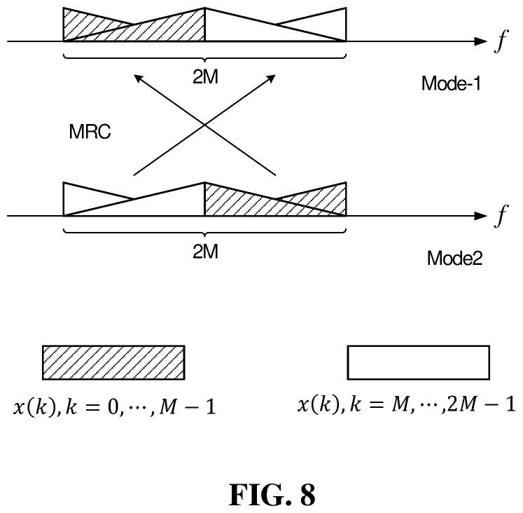

FIG. 8 includes plots illustrating frequency domain signals corresponding to a transmission and a retransmission according to the embodiment in FIGS. 6 and 7. At a receiver, combining such as MRC may be applied to combine the mode-2 received signal with the mode-1 received signal, as shown in FIG. 8. Each frequency domain component in the shifted version of the signal (mode-2) is combined with the corresponding pre-shift frequency domain component (mode-1). Combining provides cross sub-band frequency diversity in this example.

After, or along with, combining of different versions of received signals, additional processing such as single-tap based minimum mean square error (MMSE) equalization can be applied to derive the final {y(k)}. In the example expressions for y above, the numerators apply MRC combining and MMSE equalization is applied in the denominators. Equalization-based derivation of the final {y(k)} may be the same as in a single-mode approach.

Mode diversity, as disclosed by way of example herein, may achieve frequency diversity in repetition-based retransmission using an SC-OQAM waveform, with little additional complexity and signaling impact.

Turning now to signaling, in some embodiments mode diversity based HARQ may involve using mode diversity when a redundancy version (RV) of a previous transmission is to be transmitted. In other words, a receiver may be configured to apply mode diversity to a received RV if it is determined that the received signal is an RV of a pre-transmitted RV or original transmission. In this sense, mode diversity could be configured as a default, in which case mode diversity need not necessarily require additional signaling. This may be useful in avoiding or at least reducing signaling cost and standardization effort associated with implementing mode diversity.

A transmitter and receiver may cyclically rotate between modes in retransmitting RVs, for example. In this manner, a transmitter and a receiver may remain synchronized in terms of current mode for transmission and reception.

Other embodiments may involve signaling between a transmitter and a receiver. For example, mode diversity as disclosed herein could be applied to ultra-reliable low latency communication (URLLC) repetitions. Suppose that a transmitter is configured to send up to four repetitions, and that the intended receiver does not receive the first repetition but receives the second repetition. In this scenario, signaling may be used to indicate to the receiver that the received repetition is the second repetition, so that the receiver can re-align receive mode diversity with the transmitter. A diversity mode indication, of mode-1 or mode-2 for example, may be included in RV information, embedded into a transmission, or provided to a receiver in separate control signaling. Separate signaling may be or include radio resource control signaling, downlink control information (DCI), or other types of signaling.

In another example, a mode diversity operation indication may be signaled to indicate whether mode diversity operation is turned on or not, for example using UE-specific signaling such as RRC or DCI signaling, broadcast signaling, or multicast signaling.

In general, mode diversity may or may not involve additional signaling. In some embodiments an existing signaling mechanism such as a 3GPP signaling mechanism may be used to simplify signaling design and standardization effort for mode diversity based retransmission.

Mode diversity for single-carrier communications can provide equal performance in a flat channel and superior performance in a frequency selective channel, relative to conventional single-carrier repetition approaches.

Although the present disclosure refers to repetition based retransmission of DFT-S-OFDM and SC-OQAM waveforms, other embodiments can have other applications, wherever retransmission may be needed. Examples include internet of things (IoT) applications, satellite communications, 6G systems, and single-carrier approaches other than DFT-S-OFDM or SC-OQAM.

For illustrative purposes, examples provided above refer to a mode-1 transmission and a mode-2 transmission. More generally, repetition can continue in an alternating fashion between mode-1 and mode-2, such as mode-1|mode-2|mode-1|mode-2| etc., until a transmitted signal is successfully received and acknowledged by a receiving device, a maximum retransmission time is reached, a maximum number of retransmissions is reached, or some other condition or threshold for ending retransmissions is satisfied.

Exploiting different modes to achieve frequency diversity in in single-carrier communications such as DFT-S-OFDM and SC-OQAM may provide a simple and effective way to achieve frequency diversity. Embodiments disclosed herein can be more effective than IR retransmission when code rate is relatively low and channel is frequency selective.

Additional complexity and cost associated with mode diversity need not be substantial. Signaling cost, for example, may be minimized or at least reduced in embodiments in which mode diversity is configured by default and a transmitter and receiver transition together through different modes between retransmissions.

Frequency diversity can be provided in a frequency selective channel, even for single-carrier communications, according to embodiments disclosed herein. Mode diversity may provide an approach to achieve frequency diversity for single-carrier communications such as DFT-S-OFDM and SC-OQAM at no or low additional complexity and signaling cost relative to other approaches. Frequency hopping, for example, involves at least additional demodulation reference signal (DM-RS) cost. Also, frequency hopping is often not feasible in wideband retransmission.

The more frequency selective a channel is, the larger the performance degradation of DFT-S-OFDM and SC-OQAM relative to OFDM is expected to be. Embodiments disclosed herein can help narrow the performance gap between OFDM and DFT-S-OFDM or SC-OQAM in a simple and effective way.

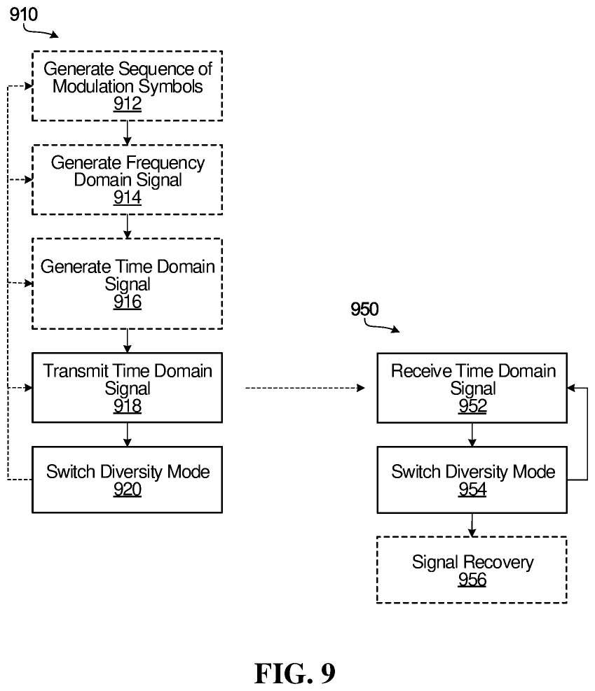

DFT-S-OFDM or SC-OQAM are examples of single-carrier systems or approaches that may benefit from mode diversity as disclosed herein. More generally, a method may involve transmitting a first time domain signal and transmitting a second time domain signal. FIG. 9 is a flow diagram illustrating an example transmit-side method at 910, and transmitting first and second time domain signals are embodied in operation 918, diversity mode switching at 920, and a dashed return arrow from 920, according to which a second time domain signal associated with a different diversity mode is transmitted.

The first time domain signal is based on a first frequency domain signal. The first frequency domain signal includes multiple frequency domain components and results from conversion of a sequence of modulation symbols, such as QAM symbols, to frequency domain. Similarly, the second time domain signal is based on a second frequency domain signal. The second frequency domain signal is consistent with a cyclic shift of the frequency domain components of the first frequency domain signal. Transmitting the first time domain signal and transmitting the second time domain signal are a transmission and a retransmission related to an input from which the sequence of modulation symbols is generated.

Examples that are provided elsewhere herein may involve generating the first time domain signal at 916 by applying a transform to the first frequency domain signal after resource mapping of the first frequency domain signal, and generating the second time domain signal, at 916 on a return from 920 in the example shown, by applying the transform to the second frequency domain signal after resource mapping of the second frequency domain signal. This is illustrative of how a time domain signal may be based on a frequency domain signal. An IFFT as referenced at least above is an example of a transform that may be used to generate a time domain signal from a frequency domain signal.

Another transform, such as a DFT as referenced at least above, may be applied to a sequence of modulation symbols to generate a frequency domain signal at 914. For example, some embodiments involve applying a transform to the sequence of modulation symbols to generate the frequency domain signal.

Generation of the second frequency domain signal, at 914 on a return from 920 in the example shown, may involve applying the cyclic shift to the frequency domain components of the first frequency domain signal. Thus, in some embodiments the second frequency domain signal may be generated from the first frequency domain signal.

In other embodiments, modulation symbols may be re-converted to frequency domain for generation of the second frequency domain signal. For example, a method may involve applying the transform, which was used to generate the first frequency domain signal, to the sequence of modulation symbols to generate a third frequency domain signal; and then applying the cyclic shift to frequency domain components of the third frequency domain signal to generate the second frequency domain signal.

Another possible option involves applying a transform to the sequence of modulation symbols to generate the first frequency domain signal; applying an operation to the input to generate a modified input; modulating the modified input, at 912 on a return from 920 in the example shown, to generate a modified sequence of modulation symbols; and applying the transform to the modified sequence of modulation symbols at 914 to generate the second frequency domain signal. This is illustrative of an embodiment in which an operation that is applied to the input results in a second frequency domain signal that is consistent with a cyclic shift of the frequency domain components of the first frequency domain signal. Thus, not every embodiment necessarily involves applying a cyclic shift to frequency domain components of a frequency domain signal.

According to another embodiment, a method involves applying a transform to the sequence of modulation symbols at 914 to generate the first frequency domain signal; applying an operation to the sequence of modulation symbols to generate a modified sequence of modulation symbols at 912 on a return from 920 in the example shown; and applying the transform to the modified sequence of modulation symbols at 914 to generate the second frequency domain signal. This is another embodiment in which the second frequency domain signal is consistent with a cyclic shift of the frequency domain components of the first frequency domain signal without applying the cyclic shift to the frequency domain components of the first frequency domain signal. One example of an operation that may be applied to modulation symbols is reversing signs of alternate symbols in a sequence of modulation symbols, as referenced at least above.

In a more general sense, “transform” may refer to transforming or otherwise converting between signals. As an example, generation of time domain signals may involve applying a first transform to a sequence of modulation symbols at 914 and 916 to generate the first time domain signal, and applying a second transform to the sequence of modulation symbols, at 914 and 916 on a return from 920 in the example shown, to generate the second time domain signal. The first and second transforms in this context may involve multiple processing steps or operations. For example, the first transform may include a DFT at 914 and an IFFT at 916, and the second transform may include a DFT at 914, a cyclic shift of frequency domain components of the DFT output, and then an IFFT at 916. A transform as referenced herein may therefore include a single transform for converting between time domain and frequency domain, or multiple operations including one or more transforms.

Regardless of how time domain signals are generated, according to embodiments disclosed herein one time domain signal, such as the second time domain signal referenced above, may be a redundant version of another time domain signal, such as the first time domain signal referenced above.

Some steps are shown in dashed lines at 910 in FIG. 9 to illustrate that those items may be performed by other elements, for example. The return arrows at 910 in FIG. 9 are intended to illustrate that switching modes between retransmissions, for example, may involve one or more of generating a sequence of modulation symbols, generating a frequency domain signal, and generating a time domain signal in addition to transmitting a time domain signal.

Features other than or in addition to those shown in FIG. 9 may be provided in some embodiments. For example, as disclosed elsewhere herein, mode switching and repetition can continue until a transmitted signal is successfully received and acknowledged by a receiving device, a maximum retransmission time is reached, a maximum number of retransmissions is reached, or some other condition or threshold for ending retransmissions is satisfied. A condition or threshold check may be made in some embodiments, and there may be no diversity mode switching or return from 920 when such a condition or threshold is satisfied.

The present disclosure is not limited to methods. Apparatus embodiments and computer program product embodiments, for example, are also contemplated.

An apparatus may include a processor and a non-transitory computer readable storage medium, coupled to the processor, storing programming for execution by the processor. FIG. 3, for example, illustrates a processor 210, 260, 276 and a memory 208, 258, 278 as an example of a non-transitory computer readable storage medium, in an ED 110, a T-TRP 170, and an NT-TRP 172. A non-transitory computer readable storage medium need not necessarily be provided only in combination with a processor, and may be provided separately in a computer program product, for example.

The programming stored in or on a non-transitory computer readable storage medium may include instructions to, or to cause a processor to, transmit a first time domain signal that is based on a first frequency domain signal and to transmit a second time domain signal that is based on a second frequency domain signal. The first frequency domain signal results from conversion of a sequence of modulation symbols to frequency domain and includes multiple frequency domain components, and the second frequency domain signal is consistent with a cyclic shift of the frequency domain components of the first frequency domain signal. Transmitting the first time domain signal and transmitting the second time domain signal are a transmission and a retransmission related to an input from which the sequence of modulation symbols is generated.

Other features disclosed herein may also or instead be implemented in apparatus embodiments or computer program product embodiments. For example, any of the following features may be provided, individually or in any of various combinations:
the programming further includes instructions to, or to cause a processor to: generate the first time domain signal by applying a transform to the first frequency domain signal after resource mapping of the first frequency domain signal, and generate the second time domain signal by applying the transform to the second frequency domain signal after resource mapping of the second frequency domain signal;
the programming further includes instructions to, or to cause a processor to: apply a transform to the sequence of modulation symbols to generate the first frequency domain signal;
the programming further includes instructions to, or to cause a processor to: apply the transform to the sequence of modulation symbols to generate a third frequency domain signal, and apply the cyclic shift to frequency domain components of the third frequency domain signal to generate the second frequency domain signal;
the programming further includes instructions to, or to cause a processor to: apply the cyclic shift to the frequency domain components of the first frequency domain signal to generate the second frequency domain signal;
the programming further includes instructions to, or to cause a processor to: apply a transform to the sequence of modulation symbols to generate the first frequency domain signal, apply an operation to the input to generate a modified input, modulate the modified input to generate a modified sequence of modulation symbols, and apply the transform to the modified sequence of modulation symbols to generate the second frequency domain signal;
the programming further includes instructions to, or to cause a processor to: apply a transform to the sequence of modulation symbols to generate the first frequency domain signal, apply an operation to the sequence of modulation symbols to generate a modified sequence of modulation symbols, and apply the transform to the modified sequence of modulation symbols to generate the second frequency domain signal;
the operation involves reversing signs of alternate symbols in the sequence of modulation symbols;
the programming further includes instructions to, or to cause a processor to: apply a first transform to the first frequency domain signal to generate the first time domain signal, and apply a second transform to the second frequency domain signal to generate the second time domain signal;
the second time domain signal is a redundant version of the first time domain signal and provides diversity in the frequency domain.

Other features, including those disclosed herein in the context of method embodiments, may also or instead be implemented in apparatus or computer program product embodiments.

From a receive-side perspective, may involve receiving a first time domain signal that is based on a first frequency domain signal, and receiving a second time domain signal that is based on a second frequency domain signal. These receiving features are shown by way of example in FIG. 9 at 950, as an operation at 952 of receiving a time domain signal, and switching diversity mode at 954 and a return from 954 to 952.

As disclosed herein for other embodiments, the first frequency domain signal results from conversion of a sequence of modulation symbols to frequency domain and includes multiple frequency domain components, the second frequency domain signal is consistent with a cyclic shift of the frequency domain components of the first frequency domain signal, and the first time domain signal and the second time domain signal are transmitted as a transmission and a retransmission related to an input from which the sequence of modulation symbols was generated.

A receive-side method may also involve recovering the input based on combining the received first time domain signal and the received second time domain signal. In some embodiments, signal recovery involves other operations as well, such as equalization for example. Signal recovery is shown in FIG. 9 as an optional feature in dashed lines at 956.

Embodiments may also or instead include other features, such as any one or more of the following:
the first time domain signal was generated by applying a transform to the first frequency domain signal after resource mapping of the first frequency domain signal, and the second time domain signal was generated by applying the transform to the second frequency domain signal after resource mapping of the second frequency domain signal;
a transform was applied to the sequence of modulation symbols to generate the first frequency domain signal;
the transform was applied to the sequence of modulation symbols to generate a third frequency domain signal, and the cyclic shift was applied to frequency domain components of the third frequency domain signal to generate the second frequency domain signal;
the cyclic shift was applied to the frequency domain components of the first frequency domain signal to generate the second frequency domain signal;
a transform was applied to the sequence of modulation symbols to generate the first frequency domain signal, an operation was applied to the input to generate a modified input, the modified input was modulated to generate a modified sequence of modulation symbols, and the transform was applied to the modified sequence of modulation symbols to generate the second frequency domain signal;
a transform was applied to the sequence of modulation symbols to generate the first frequency domain signal, an operation was applied to the sequence of modulation symbols to generate a modified sequence of modulation symbols, and the transform was applied to the modified sequence of modulation symbols to generate the second frequency domain signal;
the operation involves reversing signs of alternate symbols in the sequence of modulation symbols;
a first transform was applied to the first frequency domain signal to generate the first time domain signal, and a second transform was applied to the second frequency domain signal to generate the second time domain signal;
the second time domain signal is a redundant version of the first time domain signal and provides diversity in the frequency domain.

Other features, including those disclosed herein in the context of transmit-side method embodiments or receive-side method counterparts, may also or instead be implemented in receive-side method embodiments. For example, a receive-side method may involve acknowledging successful signal recovery at 956 so that a transmitter or transmitting device can halt or abort further retransmissions.

Anon-transitory computer readable storage medium, whether coupled to a processor in an apparatus or provided as a computer program product, may store programming that includes instructions to, or to cause a processor to, receive a first time domain signal that is based on a first frequency domain signal, and to receive a second time domain signal that is based on a second frequency domain signal. As in other embodiments, the first frequency domain signal results from conversion of a sequence of modulation symbols to frequency domain and includes multiple frequency domain components, and the second frequency domain signal is consistent with a cyclic shift of the frequency domain components of the first frequency domain signal. The first time domain signal and the second time domain signal are transmitted as a transmission and a retransmission related to an input from which the sequence of modulation symbols was generated.

Other features disclosed herein may also or instead be implemented in apparatus embodiments or computer program product embodiments. For example, any of the following features may be provided, individually or in any of various combinations:
the programming further includes instructions to, or to cause a processor to, recover the input based on combining the received first time domain signal and the received second time domain signal;
at a transmit side or by a transmitting device, the first time domain signal was generated by applying a transform to the first frequency domain signal after resource mapping of the first frequency domain signal, and the second time domain signal was generated by applying the transform to the second frequency domain signal after resource mapping of the second frequency domain signal;
at a transmit side or by a transmitting device, a transform was applied to the sequence of modulation symbols to generate the first frequency domain signal;
at a transmit side or by a transmitting device, the transform was applied to the sequence of modulation symbols to generate a third frequency domain signal, and the cyclic shift was applied to frequency domain components of the third frequency domain signal to generate the second frequency domain signal;
at a transmit side or by a transmitting device, the cyclic shift was applied to the frequency domain components of the first frequency domain signal to generate the second frequency domain signal;
at a transmit side or by a transmitting device, a transform was applied to the sequence of modulation symbols to generate the first frequency domain signal, an operation was applied to the input to generate a modified input, the modified input was modulated to generate a modified sequence of modulation symbols, and the transform was applied to the modified sequence of modulation symbols to generate the second frequency domain signal;
at a transmit side or by a transmitting device, a transform was applied to the sequence of modulation symbols to generate the first frequency domain signal, an operation was applied to the sequence of modulation symbols to generate a modified sequence of modulation symbols, and the transform was applied to the modified sequence of modulation symbols to generate the second frequency domain signal;
the operation involves reversing signs of alternate symbols in the sequence of modulation symbols;
at a transmit side or by a transmitting device, a first transform was applied to the first frequency domain signal to generate the first time domain signal, and a second transform was applied to the second frequency domain signal to generate the second time domain signal;
the second time domain signal is a redundant version of the first time domain signal and provides diversity in the frequency domain.

Other features, including those disclosed herein in the context of method embodiments, may also or instead be implemented in receive-side or receiving device apparatus or computer program product embodiments.

What has been described is merely illustrative of the application of principles of embodiments of the present disclosure. Other arrangements and methods can be implemented by those skilled in the art.

For example, although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment could be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In addition, although described primarily in the context of methods and apparatus, other implementations are also contemplated, as instructions stored on a non-transitory computer-readable medium, for example. Such media could store programming or instructions to perform any of various methods consistent with the present disclosure.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
transmitting a first time domain signal that is based on a first frequency domain signal, the first frequency domain signal resulting from conversion of a sequence of modulation symbols to frequency domain and comprising a plurality of frequency domain components; and
transmitting a second time domain signal that is based on a second frequency domain signal, the second frequency domain signal being consistent with a cyclic shift of the frequency domain components of the first frequency domain signal,
wherein transmitting the first time domain signal and transmitting the second time domain signal comprise a transmission and a retransmission related to an input from which the sequence of modulation symbols is generated.

2. The method of claim 1, further comprising:
generating the first time domain signal by applying a transform to the first frequency domain signal after resource mapping of the first frequency domain signal;
generating the second time domain signal by applying the transform to the second frequency domain signal after resource mapping of the second frequency domain signal.

3. The method of claim 1, further comprising:
applying a transform to the sequence of modulation symbols to generate the first frequency domain signal.

4. The method of claim 3, further comprising:
applying the transform to the sequence of modulation symbols to generate a third frequency domain signal;
applying the cyclic shift to frequency domain components of the third frequency domain signal to generate the second frequency domain signal.

5. The method of claim 1, further comprising:
applying the cyclic shift to the frequency domain components of the first frequency domain signal to generate the second frequency domain signal.

6. An apparatus comprising:
a processor; and
a non-transitory computer readable storage medium, coupled to the processor, storing programming for execution by the processor, the programming including instructions to cause the apparatus to:
transmit a first time domain signal that is based on a first frequency domain signal, the first frequency domain signal resulting from conversion of a sequence of modulation symbols to frequency domain and comprising a plurality of frequency domain components; and
transmit a second time domain signal that is based on a second frequency domain signal, the second frequency domain signal being consistent with a cyclic shift of the frequency domain components of the first frequency domain signal,
wherein transmitting the first time domain signal and transmitting the second time domain signal comprise a transmission and a retransmission related to an input from which the sequence of modulation symbols is generated.

7. The apparatus of claim 6, the programming further including instructions to cause the apparatus to:
generate the first time domain signal by applying a transform to the first frequency domain signal after resource mapping of the first frequency domain signal;
generate the second time domain signal by applying the transform to the second frequency domain signal after resource mapping of the second frequency domain signal.

8. The apparatus of claim 6, the programming further including instructions to cause the apparatus to:
apply a transform to the sequence of modulation symbols to generate the first frequency domain signal.

9. The apparatus of claim 8, the programming further including instructions to cause the apparatus to:
apply the transform to the sequence of modulation symbols to generate a third frequency domain signal;
apply the cyclic shift to frequency domain components of the third frequency domain signal to generate the second frequency domain signal.

10. The apparatus of claim 6, the programming further including instructions to cause the apparatus to:
apply the cyclic shift to the frequency domain components of the first frequency domain signal to generate the second frequency domain signal.

11. A method comprising:
receiving a first time domain signal that is based on a first frequency domain signal, the first frequency domain signal resulting from conversion of a sequence of modulation symbols to frequency domain and comprising a plurality of frequency domain components; and
receiving a second time domain signal that is based on a second frequency domain signal, the second frequency domain signal being consistent with a cyclic shift of the frequency domain components of the first frequency domain signal,
wherein the first time domain signal and the second time domain signal are transmitted as a transmission and a retransmission related to an input from which the sequence of modulation symbols was generated.

12. The method of claim 11,
wherein the first time domain signal was generated by applying a transform to the first frequency domain signal after resource mapping of the first frequency domain signal,
wherein the second time domain signal was generated by applying the transform to the second frequency domain signal after resource mapping of the second frequency domain signal.

13. The method of claim 11, wherein a transform was applied to the sequence of modulation symbols to generate the first frequency domain signal.

14. The method of claim 13,
wherein the transform was applied to the sequence of modulation symbols to generate a third frequency domain signal;
wherein the cyclic shift was applied to frequency domain components of the third frequency domain signal to generate the second frequency domain signal.

15. The method of claim 11, wherein the cyclic shift was applied to the frequency domain components of the first frequency domain signal to generate the second frequency domain signal.

16. An apparatus comprising:
a processor; and
a non-transitory computer readable storage medium, coupled to the processor, storing programming for execution by the processor, the programming including instructions to cause the apparatus to:
receive a first time domain signal that is based on a first frequency domain signal, the first frequency domain signal resulting from conversion of a sequence of modulation symbols to frequency domain and comprising a plurality of frequency domain components; and
receive a second time domain signal that is based on a second frequency domain signal, the second frequency domain signal being consistent with a cyclic shift of the frequency domain components of the first frequency domain signal,
wherein the first time domain signal and the second time domain signal are transmitted as a transmission and a retransmission related to an input from which the sequence of modulation symbols was generated.

17. The apparatus of claim 16,
wherein the first time domain signal was generated by applying a transform to the first frequency domain signal after resource mapping of the first frequency domain signal,
wherein the second time domain signal was generated by applying the transform to the second frequency domain signal after resource mapping of the second frequency domain signal.

18. The apparatus of claim 16, wherein a transform was applied to the sequence of modulation symbols to generate the first frequency domain signal.

19. The apparatus of claim 18,
wherein the transform was applied to the sequence of modulation symbols to generate a third frequency domain signal,
wherein the cyclic shift was applied to frequency domain components of the third frequency domain signal to generate the second frequency domain signal.

20. The apparatus of claim 16, wherein the cyclic shift was applied to the frequency domain components of the first frequency domain signal to generate the second frequency domain signal.
